(19) United States
(12) Patent Application Publication
(10) Pub. No.: US 2004/0105153 A1
(43) Pub. Date: Jun. 3, 2004

(54) Device for reception and transmission of electromagnetic waves emitted by a material sample

(76) Inventors: Norbert Ramaseder, Linz (AT); Gunter Poferl, Ottensheim (AT); Josef Heiss, Linz (AT); Manfred Kreindl, Leonding (AT)

Correspondence Address: Stephen A. Soffen, DICKSTEIN SHAPIRO MORIN & OSHINSKY LLP, 2101 L Street NW, Washington, DC, 20037-1526, US

(21) Appl. No.: 10/443,892

(22) Filed: May 23, 2003

Related U.S. Application Data
(63) Continuation of application No. PCT/AT01/00380, filed on Nov. 30, 2001.

(30) Foreign Application Priority Data
Jan. 12, 2000 (AT) A 2017/2000

(51) Int. Cl. G02B 13/14

(52) U.S. Cl. 359/512; 359/350; 359/808

(57) ABSTRACT

A device for reception and transmission of electromagnetic waves in the visible and/or infrared spectral region and/or the UV-region, emitted by a gaeous, liquid or solid material sample, to an analytical unit, preferably for the determination of the temperature of the material sample. The device comprises a heat-resistant sleeve, open at the front end, with a light wave guide coupled to the analytical unit. In order to record the electromagnetic waves of high intensity, the device has a heat-resistant protective element, arranged at the front end region of the sleeve, which conducts electromagnetic waves.

The invention relates to a device for reception and transmission of electromagnetic waves in the visible and/or infrared spectral region and/or the UV-region, emitted by a gaseous, liquid or solid material sample, to an analytical unit, preferably for the determination of the temperature of the material sample, comprising a heat-resistant sleeve, open at the front end thereof, a heat-resistant protective element arranged at the front end region of the sleeve and formed from a material conducting the electromagnetic waves as well as a light wave guide transmitting the emitted electromagnetic waves to an analytical unit.

Regarding the manufacture of steel in a converter or another metallurgical reactor by the refining of pig iron and the treatment of other melts in such a metallurgical vessel, respectively, attempts have always been made to regulate the temperature values of the melt and/or to control a melt analysis throughout the ongoing treatment procedure as continuously and fast as possible in order to be able to keep the treatment process as short as possible and to approach the intended target analysis as closely as possible. Rapidness is necessary, in particular since the reactions of chemical conversion proceed at high speeds and hence there is the danger that it might no longer be possible to interfere with the refining process or treatment process, respectively, in due time. The extremely harsh operating conditions prevailing in such plants are not convenient for this task. For the manufacture of steel in a metallurgical reactor (converter, electric arc furnace etc.), for the secondary metallurgical treatment of steel melts or if other non-metallurgical melts (f.i. Cu, Ni, Al) are used, it furthermore constitutes an advantage to know the temperature or the analysis of the melt, respectively, after each process step.

In order to solve those problems, attempts have, for example, been made to obtain an indication of the proper time for terminating the refining process from a spectral analysis of the converter flame or from the absorbing effect thereof on monochromatic light of a particular wavelength. However, the strongly varying blowing conditions and the foaming slag on the melting bath as well as the large content of dust in the offgas do not permit a sufficiently exact conclusion on the temperature of the bath and the analysis of the melt.

Regarding the temperature measurement, it furthermore was suggested (DE-B -14 08 873) to insert encapsulated thermoelements in the fireproof assembly of the converter, which thermoelements project into the interior of the converter and lie under the bath level of the melt to be refined if the converter is in its working position. However, the durability of those thermoelements was insufficient; in addition, the necessarily intense cooling of the measuring device impairs the measuring results.

Furthermore, it is known to determine the temperature of a melt at a certain point of time by means of a lance dipped into the melt. If the steel is manufactured in a converter, said process is disadvantageous, since, to that end, the converter has to be tilted and brought back into an upright position, which causes a temperature loss of the steel bath of up to 40° C. The process furthermore is time-consuming, since at first, before the converter is tilted, the blow lance has to be extended, and, after measuring has been completed, the converter has to be brought back into an upright position, only whereupon—if necessary—the blow lance can be retracted and blowing may be resumed. Further disadvantages result from the fact that the measuring point can be chosen only randomly in the melt, i.e. it hardly is reproducible. Furthermore, the immersion depth of the probe is not accurately ascertainable, either, and hence also is hardly reproducible.

In order to measure the temperature of hot material samples, it is known from JP 56-117134 A2 to use a light sensor, which, however, must be protected against the radiation of heat in a costly manner due to its temperature sensitivity. Thus, the construction known from said document is provided with a sleeve with a quartz rod inserted in the front end thereof. In said sleeve, there is another sleeve in the interior of which the light sensor is arranged. Between the glass rod and the light sensor, there is an insulating glass at the front end of the inner sleeve. The light sensor transforms the electromagnetic rays emitted by the material sample into voltage impulses, whereby simple transmission of said transformed signals to a detector installed in another, more remote place is possible, which, however, is associated with the drawback that the temperature-sensitive light sensor is hardly suitable for use at high temperatures occurring, for instance, in the harsh conditions of the metallurgical industry, or is interference-prone at high temperatures.

The determination of a chemical analysis of the melt turns out to be significantly more complicated. For that purpose, it is known to draw samples with the aid of lances dipped into the melt. That results in disadvantages for the manufacture of steel in a converter, since also this kind of sample drawing is time-consuming—also in this case the converter has to be tilted (except if measuring is carried out with vertical sublances)—and the sample must be taken to the laboratory.

If the steel is manufactured in a converter, it is known to carry out a quick carbon analysis by measuring the critical points of temperature and C-content. However, in doing so it only is possible to detect the C-equivalent so that some of the accompanying elements present in the melt must be taken into account for calculating the actual carbon content.

Furthermore, it is known to carry out evaluations of carbon and oxygen activities as well as sample drawings and temperature measurements in a converter with the aid of sublances. However, this is disadvantageous in that the sublance means themselves (and also the samples) are very expensive, are subject to excessive wear and can be used only with liquid slags toward the end of the blowing process.

From EP-B-0 162 949, a process for monitoring the formation of slag in a messemer-steel converter is known, wherein the luminous radiation emitted by the slag surface in the converter space is made use of. In doing so, the light is photoelectrically converted into signals and is processed, whereby changes to the signals are assessed as criteria for the formation of foamed slag. The receptors embedded in the side wall of the converter are located above the slag/melting bath and are unsuitable for measuring the temperature of the melting bath and the composition of the melt.

From U.S. Pat. No. 4,830,601, a process and the device for the spectrometric evaluation of light emitted from the centre of a burner flame are known. In doing so, the supply of fuel and combustion air is examined by way of the light spectrum. Via glass-fibre lines, the emitted light is supplied to an electronic evaluation unit, and the supply of combustion air arid fuel is regulated in accordance with the evaluated analysis of the gas.

A similar assembly for measuring the temperature in a process for the production of reducing gas in a high-temperature reactor at an increased operating pressure can be gathered from DE-A-40 25 909.

From EP-A-0 215 483 it is known to elicit the chemical composition of the iron by blowing oxygen or an oxygen-containing gas from above onto the surface of the molten iron, whereby rays emitted by the surface of the melt are detected in a spectrometer for determining the chemical composition of the iron.

From U.S. Pat. No. 4,619,533 and EP-A-0 362 577, devices of a similar kind as initially described are known, whereby, in the former case, rays coming from the metal melt are sent to a detector via a light wave guide. According to EP-A-0 362 577, laser light is focussed onto the metal surface, whereby a plasma is generated. Via a lens system and a light wave guide, the plasma light emitted by the metal surface is supplied to a spectrometer for the purpose of elemental analysis. The lens system is provided with adjustable lenses. The lenses are adjusted such that the ratio between the intensities of two iron lines, i.e. the intensity of an atom line and the intensity of an ion line, is minimal.

From WO 97/22859 A it is known to create a hollow space by blowing gas into the melt in order to determine the electromagnetic waves coming from the interior of a melt and to monitor said hollow space by means of an optical system coupled to a detector for determining the temperature and/or the chemical composition, whereby the electromagnetic waves coming from the material sample, i.e. the melt, are fed via a lens system into a light wave guide. In doing so, it is a problem to sufficiently receive the electromagnetic waves in order to ensure high intensity of the electromagnetic waves to be evaluated.

From U.S. 4,037,473 A a device of the initially described kind is known, wherein the light wave guide is partially separated from the material sample by being covered by a heatresistant protective element. Said protective element is either configured as an apertured diaphragm or as a so-called collimator, i.e. as a block with capillary tubes. In both cases, the electromagnetic waves get to the light wave guide through openings, i.e. through the slit of the slit diaphragm or through the capillary tubes. The device known from said document is a device exclusively for measuring the temperature of gas turbines comprising optical filters for suppressing the electromagnetic waves of longer wavelengths in order to prevent them from reaching a dedector.

A measuring device according to the preamble of claim 1 is known from U.S. 3,745,834 A and WO 98/46971. It is equipped with a protecting tube, in which a first element consisting of a sapphire and, subsequently thereto, a silicon crystal are provided. Both the protecting tube and the sapphire element extend to the melt and directly contact the same.

The invention aims at avoiding those disadvantages and difficulties and has as its object to improve a device for carrying out the process described in WO 97/22859 A such that an intensity of the electromagnetic waves to be processed as high as possible and a smooth transmission of said waves to an analytical unit by means of a light wave guide are provided. Another object consists in providing the possibilty of easily repairing and maintaining the device with small expenditures of human labour and material being involved. The device is supposed to be usable especially for particularly hot material samples.

With a device of the initially described kind, said object is achieved according to the invention in that the protective element can be flushed by a circulation gas, as the sleeve, on its outside, is surrounded by an outer sleeve forming a casing, whereby an annular gap passed through by a flushing medium is formed between the sleeve and the outer sleeve.

It is known to supply a protective gas in order to prevent the melt from contacting the measuring device (U.S. Pat. No. 3,747,408, 4,037,473 and EP 0 362 577 A). Thereby, quartz windows serve to prevent the supplied protective gas from advancing to the measuring device or to prevent the melt, respectively, from advancing to the measuring device, such as into a casing in which a laser generating device and various lens systems are incorporated (EP 0 362 577 A).

A preferred embodiment for reception and transmission of electromagnetic waves in the visible and/or infrared spectral region and/or the UV-region, emitted by a solid material sample, to an analytical unit, preferably for the determination of the temperature of the material sample, is characterized by a combination of the following features:

a heat-resistant sleeve (5), open at the front end thereof, in which a light wave guide (14), coupled to an analytical unit, is provided,

a heat-resistant protective element (12) arranged at the front end region of the sleeve (14), which protective element is formed from a material conducting the electromagnetic waves, and

an apertured diaphragm (11) which lies between the material sample (2, 17) and the protective element (12).

In order to avoid loss of intensity or to increase intensity, respectively, at the transition of the electromagnetic waves from the protective element to the light wave guide, an optical refraction device, such as a lens system, preferably is provided between the protective element and the light wave guide.

In order to make sure that the intensity of the transmitted electromagnetic waves is as high as possible, the light wave guide suitably is arranged so as to be displaceable relative to the protective element. In doing so, it may suffice if the light wave guide is displaceable relative to the protective element while being adjusted for the first time.

According to a preferred embodiment, the optical refraction device is relocatable relative to the protective element while the distance to the protective element is varied.

Preferably, the end region of the sleeve that receives the protective element is provided with an apertured diaphragm which lies between the material sample and the protective element.

A preferred variant is characterized in that the outer sleeve surmounts the sleeve in the axial direction.

For liquid material samples, such as metal melts, the outer sleeve suitably is inserted in a wall of a metallurgical vessel, which wall is made of a fireproof material, and penetrates through said wall right into the interior of the metallurgical vessel.

According to another embodiment to be used for melts, the device is inserted in a measuring lance.

For particularly high temperatures, a deflection device preferably is provided between the protective element and the light wave guide, preferably between an optical refraction device arranged behind the protective element and the light wave guide.

According to a preferred variant, the protective element is shaped as a rod and the rod has a ratio of length to diameter of 2:1, preferably of 3:1 or more, with the diameter of the protective element advantageously at least equal to the diameter of the light wave guide. It may be appropriate if the diameter of the protective element is dimensioned so as to be 10 to 30% larger than the diameter of the light wave guide.

Preferably, the optical refraction device is configured as a focussing device.

In order to obtain particularly accurate measuring results, according to a preferred embodiment, an inert gas or an optically neutral liquid is provided between the protective element and the light wave guide and/or between the protective element and the optical refraction device and/or between the optical refraction device and the light wave guide.

For high temperatures, the protective element advantageously is made of quartz.

According to a preferred embodiment, the protective element is formed from a plurality of optical fibres, in particular from a strand of fibre-shaped light wave guides.

In order to avoid a falsification of measuring results, in a process for operating the device according to the invention, a temperature the level of which falls in the range of the actual temperature of the material sample advantageously is maintained between the end of the protective element directed toward the material sample and the material sample, whereby the deviation of the temperature of the material sample from that of the protective element suitably amounts to ±20% at the most. To that end, a preselected temperature suitably is adjusted and maintained between the material sample and the protective element by supplying a gas or a gas mixture.

For the purpose of accurately measuring the temperature, it may be advantageous if the protective element is brought into direct contact with the material sample and the protective element is formed from a material which is chemically inalterable by the material sample and has a melting point or softening point, respectively, which is above the temperature of the material sample.

Below, the invention is described in more detail by way of several exemplary embodiments schematically illustrated in the drawing.

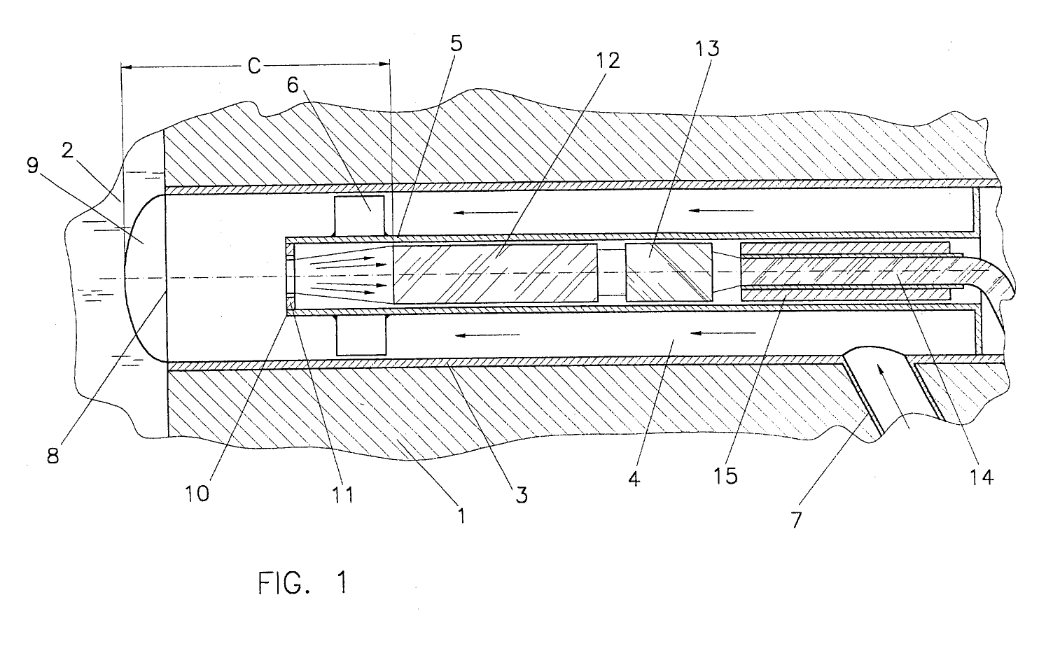

FIG. 1 shows a longitudinal section through a device according to the invention which is used in a metallurgical vessel, preferably for measuring the temperature of a steel bath.

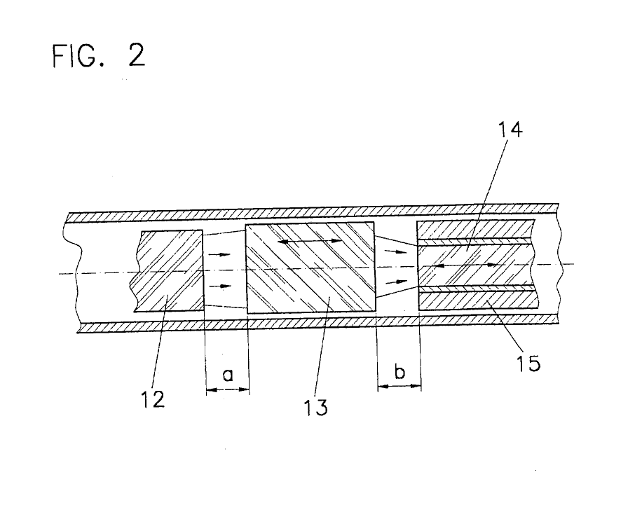

FIG. 2 shows a detail of FIG. 1 on an enlarged scale.

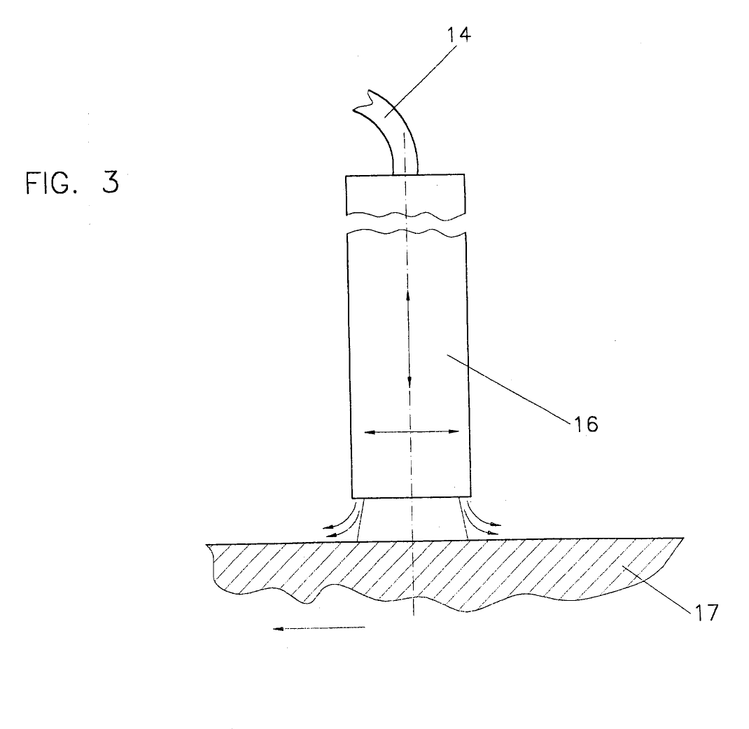

FIG. 3 illustrates, in side view, the use of the device according to the invention in a measuring lance.

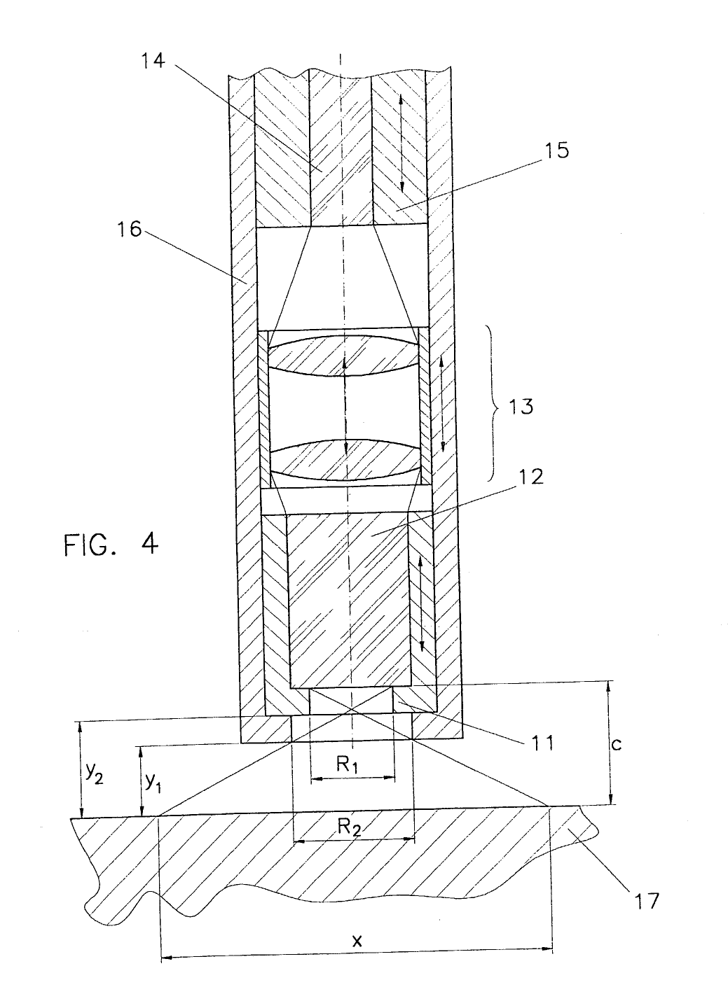

FIG. 4 shows a longitudinal section through the device according to the invention which is used in the measuring lance.

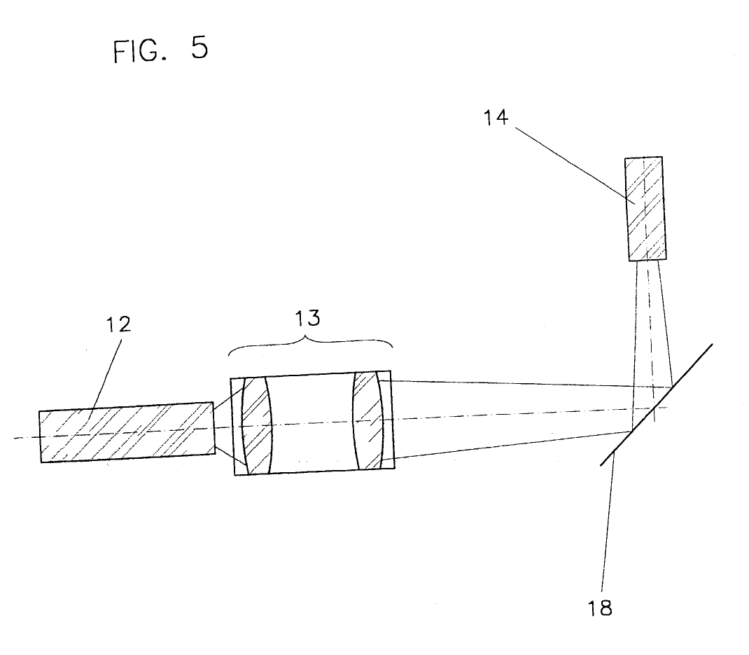

FIG. 5 is a schematic illustration of the essential parts of the device according to the invention, with the electromagnetic waves to be evaluated being deflected.

According to the embodiment shown in FIG. 1, a boring, into which an outer sleeve 3 is inserted, is provided in the fireproof lining 1 of a metallurgical vessel, in which f.i. a steel bath 2 is located. An inner sleeve 5 having an outside diameter that is smaller than the inside diameter of the outer sleeve 3 is inserted in said outer sleeve 3, with an annular gap 4 being spared. In order to secure an annular gap 4 of uniform width, spacers 6 radially projecting outwards, which centre the inner sleeve 5 in the outer sleeve 3, are provided at the inner sleeve 5.

Via a supply line 7, a flushing medium can be conducted through the annular gap 4 to the front end 8 of the outer sleeve 3, whereby the steel bath 2 can be prevented from entering the outer sleeve 3. That leads to the formation of a hollow space 9 convexly projecting into the steel bath 2 and filled by a flushing medium, preferably a gas.

The front end 10 of the inner sleeve 5 is provided with an apertured diaphragm 11 in order to prevent the electromagnetic waves coming from the marginal region of the steel melt to be observed through the hollow space 9 from being detected. In the interior of the inner sleeve 5, a protective element shaped as a light rod 12 is located right behind the apertured diaphragm 11, a lens system 13 is provided behind the light rod 12, and, at a distance a, a light wave guide 14, f.i. a glass-fibre cable, which is embedded in a support 15 and is positioned at a distance b from the lens system 13, is provided behind the lens system 13.

The ductible light wave guide 14 transmits the electromagnetic waves, emitted by the steel bath 2 in the visible and/or infrared spectral region and/or the UV-region, to an analytical unit not illustrated further, by means of which the temperature of the steel bath 2 and/or its chemical composition are determinable in a manner known per se, such as described, for instance, in WO-A-97/22859.

Both the outer sleeve 3 and the inner sleeve 5 are made of a heat-resistant material, with the inner sleeve 3 functioning as a protecting tube for the light rod 12, the lens system 13 as well as the front end region of the light wave guide 14. The inner sleeve 5 can, for instance, be made of steel.

The light rod 12 is formed from a heat-resistant material conducting the electromagnetic waves to be evaluated, for instance from glass or quartz, whereby the material of the light rod 12, i.e. its refractive index, is chosen according to its specific task of transmitting electromagnetic waves for the temperature determination in the infrared spectral region and/or for determining the chemical composition in the UV-region. The ratio of length to diameter may amount to between 2:1 and 5:1, preferably it is above 3:1.

Said light rod 12 serves as a protective element for the protection of the lens system 13 and the front end region of the light wave guide 14. Said light rod 12 permits that a short distance c to the material sample to be monitored and measured, in the present case to the steel bath 2, is maintained. In doing so, it is possible to ensure that the electromagnetic waves to be evaluated are of high intensity and that they are gathered and transmitted to the lens system 13 and further on to the analytical unit in a manner as smooth and loss-free as possible. Another advantage of the light rod 12 consists in that it can be exchanged or cleaned easily in case it is damaged or soiled, without any high costs in terms of labour or material accruing.

According to a variant of the device according to the invention, the introduction of the electromagnetic waves into the light wave guide 14 may also be performed directly from the light rod 12 into the light wave guide 14, i.e. without the interposition of a lens system 13. However, the lens system 13 provides the advantage that the electromagnetic waves coming or originating, respectively, from the light rod 12 can be focussed onto the light wave guide 14 by appropriately positioning the lens system 13 which optionally is arranged in the inner sleeve 5 so as to be longitudinally displaceable —such as illustrated by the double arrow 15. Furthermore, it may be advantageous to arrange the end region of the light wave guide 14 so as to be longitudinally displaceable in the inner sleeve 5.

The device illustrated in FIG. 1 may be used especially in metallurgical processes wherein lower bath nozzles are employed as well, i.e. in convertes of various designs. The use in flushing nozzles, with which a metallurgical vessel already is equipped, may also be provided. In that case, the flushing nozzle forms the outer sleeve 3.

In addition to providing protection for the inner sleeve 5 and the fixtures thereof, the annular gap 4 as illustrated in FIG. 1 provides the advantage that it is possible to protect the outer sleeve 3 from premature wear by forming an annular protective mushroom covering the outer sleeve 3 and the adjacent fireproof material 1 at the inlet 8 of the outer sleeve 3.

By chosing an appropriate amount of flushing and an appropriate flushing medium (f.i. an inert gas etc.), the annular gap 4 or the hollow space 9, respectively, projecting into the steel bath 2, may be kept open and thus the radiation of electromagnetic waves, which is necessary for measuring, can be conducted to the analytical unit. In case the hollow space 9 should close, it may be reopened by blowing in gas enriched with oxygen, compressed air or pure oxygen.

According to a variant of the invention, a particularly effective way of measuring the temperature may be carried out in a liquid melting bath by means of a light rod 12, directly incorporated in the wall of the metallurgical vessel. In doing so, the melt contacts the surface of the light rod 12, which either, with its front end, is aligned with the inside of the wall of the metallurgical vessel or which projects therefrom. By this kind of direct contact, it is possible to eliminate falsifications of measured values. However, such direct contact only makes sense if the melt is unable to enter into a chemical reaction with the material of the light rod 12 or if the melting point or softening point, respectively, of the light rod 12 is above the temperature of the melt.

The use of the device according to the invention is particularly advantageous in the metallurgical melting technology (blast furnace, steelworks, converter, electric arc furnace, secondary metallurgy, continuous casting etc.), since the already existing process models can be supported precisely and even more accurately with the aid of the continuous temperature measurement.

Another reasonable field of application is the monitoring of hot solid bodies, in the agitated or in the motionless state. For instance, by means of a displaceable or liftable and lowerable lance 16, into which the device according to the invention is incorporated, the device according to the invention can be moved right in front of the object to be measured, i.e. the material sample 17. Such a lance 16 is illustrated in FIG. 3, for instance.

FIG. 4 shows the inner life of the lance, which also is formed by an apertured diaphragm 11, a light rod 12, a lens system 13 as well as an embedded light wave guide 14. If x indicates the region of the material sample 17 that is to be monitored, the size thereof is dependent on the free diameter R₁ of the lance 17, the free diameter R₂ of the apertured diaphragm 11, the distance c of the material sample from the light rod 12 and the respective distances Y₁ and Y₂ to the apertured diaphragm 11 or to the end of the lance 17, respectively, which can be defined as follows:

x=f(R₁, R₂, c, y₁, y₂)

According to the variant shown in FIG. 5, the light wave guide 14 is arranged in a particularly protected manner in that a deflection device 18, such as a deviation mirror, for the electromagnetic waves to be transmitted is arranged between the end of the light wave guide 14 and the lens system 13.

The formation of the protective element as a light rod 14, i.e. in the shape of a rod, consititutes a particular advantage but is not necessarily required for achieving the object of the invention. Possibly, it might also be appropriate if the protective element is dimensioned in a manner deviating from the rod shape, i.e., for example, having a length equal to or shorter than the diameter. The protective function, i.e. the protection provided to the light wave guide 14 arranged behind or, in case a lens system 13 is provided, the protection provided to the lens system 13, is essential so that the distance of the lens system 13 or of the end of the light wave guide 14, respectively, from the material sample can be kept as small as possible.

The protective element may also consist of optical fibres, with the optical fibres preferably being configured as thin round rods or fibres, f.i. made of quartz glass, which are surrounded by a casing and held together under the formation of a strand.

1. A device for reception and transmission of electromagnetic waves in the visible and/or infrared spectral region and/or the UV-region, emitted by a gaseous, liquid or solid material sample (2, 17), to an analytical unit, preferably for the determination of the temperature of the material sample (2, 17), comprising a heat-resistant sleeve (5), open at the front end thereof, a heat-resistant protective element (12) arranged at the front end region of the sleeve (14) and formed from a material conducting the electromagnetic waves as well as a light wave guide (14) transmitting the emitted electromagnetic waves to an analytical unit, characterized in that the protective element (12) can be flushed by a circulation gas, as the sleeve (5), on its outside, is surrounded by an outer sleeve (3) forming a casing, whereby an annular gap (4) passed through by a flushing medium is formed between the sleeve (5) and the outer sleeve (3).

2. A device for reception and transmission of electromagnetic waves in the visible and/or infrared spectral region and/or the UV-region, emitted by a solid material sample (2, 17), to an analytical unit, preferably for the determination of the temperature of the material sample (2, 17), characterized by a combination of the following features:
a heat-resistant sleeve (5), open at the front end thereof, in which a light wave guide (14), coupled to an analytical unit, is provided,
a heat-resistant protective element (12) arranged at the front end region of the sleeve (14), which protective element is formed from a material conducting the electromagnetic waves, and
an apertured diaphragm (11) which lies between the material sample (2, 17) and the protective element (12).

3. A device according to claim 1, characterized in that an optical refraction device (13), such as a lens system, is provided between the protective element (12) and the light wave guide (14).

4. A device according to claim 1, characterized in that the light wave guide (14) is displaceable relative to the protective element (12).

5. A device according to claim 3, characterized in that the optical refraction device (13) is relocatable relative to the protective element (12) while the distance (a) to the protective element (12) is varied.

6. A device according to claim 1, characterized in that the end region of the sleeve (5) that receives the protective element (12) is provided with an apertured diaphragm (11) which lies between the material sample (2, 17) and the protective element (12).

7. A device according to claim 1, characterized in that the outer sleeve (3) surmounts the sleeve (5) in the axial direction.

8. A device according to claim 1, characterized in that the outer sleeve (3) is inserted in a wall of a metallurgical vessel, which wall is made of a fireproof material (1), and penetrates through said wall right into the interior of the metallurgical vessel.

9. A device according to claim 1, characterized in that the device is inserted in a measuring lance (16).

10. A device according to claim 1, characterized in that a deflection device (18) is provided between the protective element (12) and the light wave guide (14), preferably between an optical refraction device (13) arranged behind the protective element (12) and the light wave guide (14).

11. A device according to claim 1, characterized in that the protective element (12) is shaped as a rod and the rod has a ratio of length to diameter of 2:1, preferably of 3:1 or more.

12. A device according to claim 1, characterized in that the diameter of the protective element (12) is at least equal to the diameter of the light wave guide (14).

13. A device according to claim 12, characterized in that the diameter of the protective element (12) is dimensioned so as to be 10 to 30% larger than the diameter of the light wave guide (14).

14. A device according to claim 3, characterized in that the optical refraction device (13) is configured as a focussing device.

15. A device according to claim 1, characterized in that an inert gas or an optically neutral liquid is provided between the protective element (12) and the light wave guide (14) and/or between the protective element (12) and the optical refraction device (13) and/or between the optical refraction device (13) and the light wave guide (14).

16. A device according to claim 1, characterized in that the protective element (12) is made of quartz.

17. A device according to claim 1, characterized in that the protective element is formed from a plurality of optical fibres, in particular from a strand of fibre-shaped light wave guides.

18. A process for operating a device according to claim 1, characterized in that a temperature the level of which falls in the range of the actual temperature of the material sample (2, 17) is maintained between the end of the protective element (12) directed toward the material sample (2, 17) and the material sample (2, 17).

19. A process according to claim 18, characterized in that the deviation of the temperature of the material sample (2, 17) from that of the protective element (12) amounts to ±20% at the most.

20. A process according to claim 18, characterized in that a preselected temperature is adjusted and maintained between the material sample (2, 17) and the protective element (12) by supplying a gas or a gas mixture.

21. A process for operating a device according to claim 1, characterized in that the protective element (12) is brought into direct contact with the material sample (2, 17) and the protective element (12) is formed from a material which is chemically inalterable by the material sample (2, 17) and has a melting point or softening point, respectively, which is above the temperature of the material sample (2, 17).
